(19) United States
(12) Patent Application Publication
(10) Pub. No.: US 2004/0160385 A1
(43) Pub. Date: Aug. 19, 2004

(54) Organization object as a first-class business modeling object, and method and system for providing same

(76) Inventor: Marc Desbiens, Ottawa (CA)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/369,963

(22) Filed: Feb. 19, 2003

(51) Int. Cl. G06F 17/60; G09G 5/00

(52) U.S. Cl. 345/7; 705/7; 705/11

(57) ABSTRACT

An organization object as a first class business modeling object, and method and system for providing same are disclosed. The organization object includes at least one data dimension reference, at least one user identifier defining intended recipients, and a mapping between each data dimension reference and at least one user identifier. The method includes the steps of referencing at least one data dimension, defining intended recipients, and mapping each data dimension reference with at least one intended recipient.

### FIELD OF THE INVENTION

The present invention relates generally to databases and data manipulation, and more particularly to the dimensional modeling of object-oriented databases.

### BACKGROUND OF THE INVENTION

In the design of computer software systems, it is considered advantageous to associate each data item with a data type, and to present a relatively uniform interface to objects of each data type to all elements of the system. This technique allows elements of the system to rely on the characteristics of the data type, of the uniform interface to that data type, and of the relationships between that data type and other data types.

In addition to so-called “built in” data types, such as integers and floating point numbers, it is also considered advantageous to extend this technique to more complex data types, called “classes,” including classes defined by the user of a system. A class represents a category of objects. For example, there might be a class called “shape” that contains objects that are circles, rectangles, and triangles. A class defines all the common properties of the different objects that belong to it. For example, a user might define a class called “telephone number”, thereby allowing elements of the system to store, manipulate, and retrieve telephone numbers as if they were fundamental pieces of information. Techniques for defining classes of data objects and restricting access to those objects are now common.

The technique of defining classes of data objects and manipulating those objects has been useful in database applications as well. In object-oriented database (OODB) applications, a user defines classes of objects, properties of those classes, and relationships between those classes, and populates a database with data items that are instances of those objects. Object-oriented database management techniques now provide the advantages of rapid application and database development, as well as relative software reliability.

Today, organizations now regularly employ so-called business intelligence (BI) tools, such as decision support systems (DSS) that leverage object-oriented data management techniques to enhance their managers' ability to make timely and accurate decisions by presenting data gathered for them from a wide range of sources. With the decisions being made by senior management based often on information passed to them by subordinates, and subordinates typically receiving only that information relevant to their area of responsibility, the result has been that dissemination of data often mimics areas of responsibility, and therefore the hierarchal structure of a business.

The problem is that today's information systems, particularly in the area of planning, have typically had to rely on manual techniques or scripts to extract data for individual users. This has meant that the knowledge of how data is extracted and assigned is often disadvantageously limited to a small group of individuals within a company. Since the extraction of data based on areas of responsibility is often repeated over on a monthly or quarterly basis for the same or different sets of data, this inherent lack of a central definition of data extraction rules based on area of responsibility results in both inefficiencies, and well as inherently inferior security.

What is needed is a way to model an organization's structure according to area of responsibility in accordance with the superior performance of object-oriented data management techniques.

For the foregoing reasons, there is a need for an improved method and system for modeling data based on area of responsibility.

### SUMMARY OF THE INVENTION

The present invention is directed to organization object as a first-class business modeling object, and method and system for providing same. The organization object includes at least one data dimension reference, at least one user identifier defining intended recipients, and a mapping between each data dimension reference and at least one user identifier.

The method includes the steps of referencing at least one data dimension, defining intended recipients, and mapping each data dimension reference with at least one intended recipient.

The system includes a module for referencing at least one data dimension, a module for defining intended recipients, and a module for mapping each data dimension reference with at least one intended recipient.

In an aspect of the present invention, a user identifier can be assigned responsibility for the cross product of multiple data dimension references, such as “Products” within “Regions”.

An organization object provides a central definition to associate dimensional data with individual responsibility within a company, providing a reusable and secure set of rules that can be verified and applied across multiple data sets, and even multiple data warehouses where such dimensional rules apply. Organization objects provide an important component of a business model since they contain information about who is responsible for which areas of a company.

As well, because an organization object can be used by an application to partition data along areas of responsibility, it provides a very powerful and flexible tool for modeling an organization.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of an organization object in accordance with an embodiment of the present invention;

FIG. 2 is an overview of a method for providing an organization object in accordance with an embodiment of the present invention;

FIG. 3 is an overview of a system for providing an organization object in accordance with an embodiment of the present invention;

FIG. 4 illustrates a management role hierarchy; and

FIG. 5 illustrates an organization with defined associations.

### DETAILED DESCRIPTION OF THE PRESENTLY PREFERRED EMBODIMENT

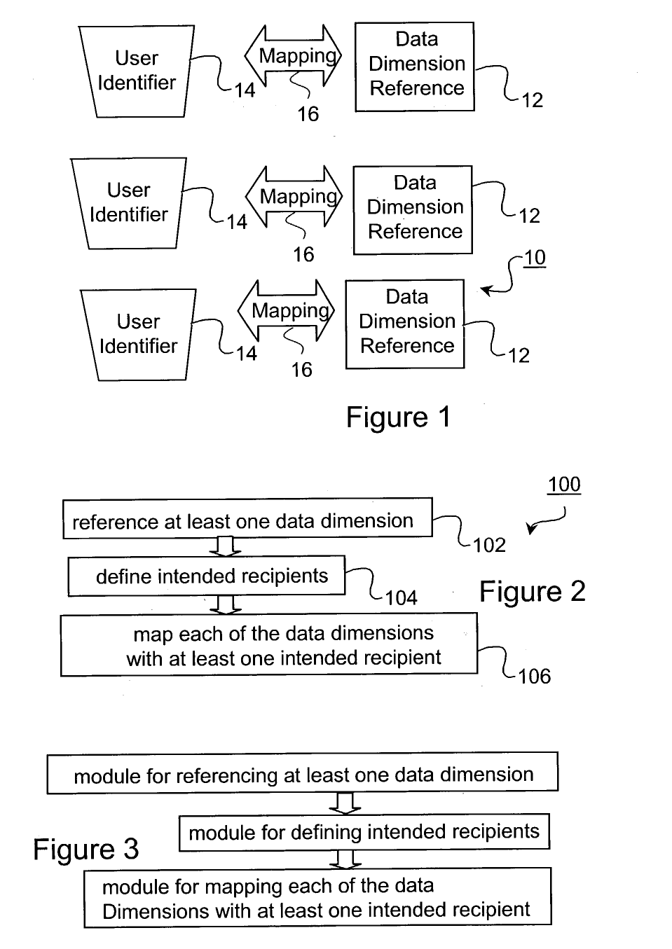

An embodiment of the present invention is directed to an organization object 10 as a first-class business modeling object, and method and system for providing same. As illustrated in FIG. 1, the organization object 10 includes at least one data dimension reference 12, at least one user identifier 14 defining intended recipients, and a mapping 16 between each data dimension reference 12 and at least one user identifier 14.

As illustrated in FIG. 2, the method 100 includes the steps of referencing at least one data dimension 102, defining intended recipients 104, and mapping each data dimension reference with at least one intended recipient 106.

As illustrated in FIG. 3, the system includes a module for referencing at least one data dimension, a module for defining intended recipients, and a module for mapping each data dimension reference with at least one intended recipient.

In an embodiment of the present invention, a user identifier 14 can be assigned responsibility for the cross-product of multiple data dimension references 12, such as “Products” within “Regions”.

An organization object 10 is a mapping of user classes to dimensional data. A user identifier 14 typically represents a role defined in an application's security model. The name of a data dimension reference 12 provides a unique reference that can be used by an application to generate subsets of data for associated user identifiers 14. The mappings 16 between each of the data dimensions 12 and user identifiers 14 define the area of responsibility for the associated user identifier 14.

Organization objects 10 are advantageously used in a delegation process to partition and deliver plan data from a master data set using a delegation object. Delegation objects are described in detail in co-pending United States patent application, entitled “Delegation Object as a First-Class Business Modeling Object, and Method and System for Providing Same” and filed on Feb. 19, 2003, the teachings of which are hereby incorporated by reference in their entirety. A delegation object contains a reference to an organization object in order to define how a master data set is to be broken out and delivered. The creation of an organization object 10 ensures that delegated plans are delivered to the appropriate people.

Organization objects 10 define relationships between dimensional data and users. The mapping to the appropriate people is done by using predefined user classes and matching them to dimension members. A user identifier 14 is advantageously derived from an application's security model. In addition, a user identifier 14 can include additional information such as a user name and/or e-mail address. Organization objects 10 contain an implied business organizational structure based on dimensional hierarchy and assigned responsibility. The hierarchy defines the flow of responsibility within an organization object 10, similar to an organization chart. Each user-identified mapping 16 has a unique name. Mappings 16 defined within an organization object 10 can be used within an application to generate multiple named data sets.

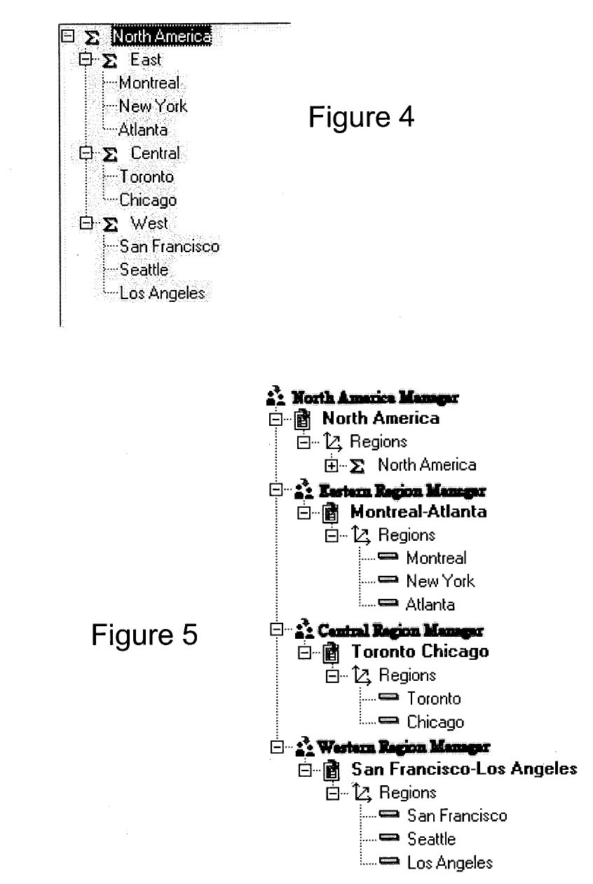

To demonstrate a simple organization object 10, the following example is provided. As illustrated in FIG. 4, Acme Inc. possesses budgeting data sets in its data warehouse that it wishes to distribute to all of its regional managers. All of the data sets contain “Region” dimensions. Further, the company maintains the defined management roles North American Manager, Eastern Region Manager, Central Region Manager, and Western Region Manager. Once defined, an organization object 10 can be used by an application to partition data along areas of responsibility.

In accordance with the aforementioned, the budget manager for Acme Inc. creates a new “organization” that defines appropriate associations, as illustrated in FIG. 5. The organization object 10, which defines responsibility along the region dimension, can be used to generate data sets for each user defined in the organization object 10 according to their particular area of responsibility with the company. From this example as well, one can determine for what regions each manager is responsible.

Organization objects 10 provide an important component of a business model since they contain information about who is responsible for which areas of a company. As illustrated in FIG. 5, one can see that the “North America Manager” role is responsible for all of “North America” and that the “Eastern Region Manager”, “Central Region Manager” and “Western Region Manager” data sets all rollup into its data set. Further, the “Eastern Region Manager” role is responsible for the “Montreal”, “New York” and “Atlanta” regions, the “Central Region Manager” role is responsible for the “Toronto” and “Chicago” regions, and so on.

Organization objects 10 are first-class business modeling objects that define named relationships between dimensional data and role-based user specifications. An organization object 10 provides a central definition to associate dimensional data with individual responsibility within a company, providing a reusable and secure set of rules that can be verified and applied across multiple data sets, and even multiple data warehouses where such dimensional rules apply. Organization objects 10 provide an important component of a business model since they contain information about who is responsible for which areas of a company.

As well, because an organization object 10 can be used by an application to partition data along areas of responsibility, it provides a very powerful and flexible tool for modeling an organization.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. An organization object as a first-class business modeling object, comprising:
at least one data dimension reference;
at least one user identifier defining intended recipients; and
a mapping between each said data dimension reference and at least one user identifier.

2. The object according to claim 1, wherein a user identifier further includes additional information including a user name and/or an e-mail address.

3. The object according to claim 1, wherein said user identifier represents an area of responsibility.

4. The object according to claim 1, wherein said user identifier is defined in an application's security module.

5. The object according to claim 1, further including filtering said organization.

6. A method for providing an organization object as a first-class business modeling object, comprising the steps of:
(i) referencing at least one data dimension;
(ii) defining intended recipients; and
(iii) mapping each said data dimensions with at least one intended recipient.

7. A system for providing an organization object as a first-class business modeling object, comprising:
a module for referencing at least one data dimension;
a module for defining intended recipients; and
a module for mapping each said data dimension reference with at least one intended recipient.

8. A storage medium readable by a computer encoding a computer process to provide a method for providing an organization object as a first-class business modeling object, comprising:
a processing portion for referencing at least one data dimension;
a processing portion for defining intended recipients; and
a processing portion for mapping each said data dimension reference with at least one intended recipient.
